(19) United States
(12) Patent Application Publication
(10) Pub. No.: US 2004/0068433 A1
(43) Pub. Date: Apr. 8, 2004

(54) Parking system with centralized reservation, payment and enforcement

(75) Inventors: Amalendu Chatterjee, Cary, NC (US); Dwijadas Raha, Raleigh, NC (US); Joseph Fobert, Chapel Hill, NC (US); Sorin Cohn-Sfetcu, Manotick (CA)

Correspondence Address: Dijadas RAHA, CEO of Eximsoft International LLC, 1851 Evans Road, Cary, NC, 27513, US

(73) Assignee: Eximsoft International

(21) Appl. No.: 10/463,321

(22) Filed: Jun. 18, 2003

Related U.S. Application Data
(60) Provisional application No. 60/412,567, filed on Sep. 23, 2002.

(51) Int. Cl. G06F 17/60

(52) U.S. Cl. 705/13

(57) ABSTRACT

A parking system for enabling centralized parking reservation, payment and enforcement, comprises a central computer communicating with user terminals and service terminals over a data network. The parking system maintains maps for all parking facilities administered by the respective owner and maintains information regarding the user of the respective vehicle; this information is particularly useful in security sensitive areas. A subscriber may access the system using a wireless or wireline web-enabled terminal, or with the help of an agent, to identify a convenient, un-reserved parking space, reserve that space (advance reservation is available) and pay a fee corresponding to the time the space was used. For subscriber's convenience, payment is cashless, and is tailored to the subscriber's needs; overtime parking protection is also available. The service terminals enable automation of most parking operations. Efficient supervision and enforcement operations of a parking facility are ensured through use of fixed or portable license plate readers (LPR). The parking supervisor/enforcer is provided with the ability to upload into the system the current parking occupancy, download maps with the expected occupancy, and issue parking tickets to offenders. The information on delinquent cars may be sent to the local authority or Department of Motor Vehicles (DMV) to identify repeat offenders for appropriate enforcement in traffic courts.

### FIELD OF THE INVENTION

The invention resides in the field of integrated parking systems and is directed in particular to a system for centralized parking reservation, payment and enforcement. In addition, the invention introduces the mobility and convenience of drivers by automation through the centralized parking system.

### BACKGROUND OF THE INVENTION

The parking industry is a over $500 billion industry in the US. There are over 105 millions parking spaces, which include metered parking spaces, garages, parking areas/lots, etc, with various methods for collection the parking fees. Collection of the parking fees is performed in a fragmented way using parking attendants, or automatic payment collection machines that accept cash, debit and/or credit cards.

The existing parking systems have a few disadvantages. For example, the municipalities provide parking meters on some streets; however typical street parking meters require cash, and accept only certain types of coins. In addition, the time that can be bought is limited (e.g. maximum one hour or two hours). Therefore, many users must reload the meter at regular intervals of time, if they need to use the facility for a longer time than the maximum time allowed by the parking meter. While willing to correctly pay the fee, the user may get fined if the parking time expires, and he/she could not reload the meter in time. The fine is the same for one minute or one hour violation, as there is no way to determine the duration of the violation.

Numerous parking lots or garages located within major cities use parking attendants, and generally accept only cash; the user is required generally to pay a deposit (cash) representing the payment for a full day. Still further, the user is charged in increments of ½ hours, so that the payment exceeds the cost for the actual parking time. In most cases, a flat parking fee is charged for parking spaces for sport events or shows. Two events may run concurrently on the same day, creating an opportunity for revenue scopes.

Most parking lots that accept overnight parking, such as e.g. airport parking lots, allow prepayment in increments of some larger time units (days, hours and minutes). Nonetheless, additional parking time cannot be bought and the car may by eventually towed at the expense of the user, if the pre-paid time expires before user's return (i.e. unplanned extended absence).

In large parking facilities that are generally provided for events with a large attendance e.g. sport events, shows, concerts, airports, etc., the parking spaces surrounding a respective venue are spread over a large area and divided into lots. It is not easy or automatic for a user to find a free spot in such a large parking area. As well, it is not easy for the parking administrator to determine when a certain lot is full, so as to re-direct the potential users to other lots in the respective parking facility. This impacts on the business, since unused parking spaces do not bring revenue.

Large parking facilities have been lately equipped with automated payment capabilities. However, the automatic cashiers differ from one parking facility to another; learning how to operate a particular type of automatic cashier, especially at night when the visibility is poor, and/or when there are other users waiting in line, could be quite stressful.

In some cases the automatic cashiers are provided at the site of the venue rather than in the parking facility; this implies that the user must carry the parking slip on him/her, while in most cases, the parking lip must be displayed on the dashboard.

If the payment is not automatic, it takes a long time to exit a large parking facility, since fee collection at the gates slows the traffic.

In addition, finding the vehicle in large parking areas/lots when the respective event is over may pose problems, especially at night, or after a heavy snow. To address this problem, many car models are equipped with handheld devices for audible recognition; however, not all vehicles have this feature and the sound is very similar for most vehicles.

Still further, looking for a parking spot may be time/fuel consuming, and requires knowledge of the area in advance, since it is not easy to read the parking signs while driving.

To summarize, there are numerous ways of managing a parking lot, and the fee collection varies widely with the city, county, province/state or country. Currently, the onus is on the user to continuously learn new methods of payment, to carry the right amount of cash and the correct coin denominations and to know in advance for how long the parking spot is needed. Currently, the only alternative is to pay extra money, to get a parking ticket, or to have the vehicle towed.

Lately, worldwide terrorist activities have added a new dimension to security of parking operations, especially in crowded areas such as metropolitan areas, large commercial centers, airport parking (which require 300 feet restriction during an orange alert) or large event venues. Increased protection measures are now being considered for securing public parking areas, in view of the events on Sep. 11, 2001. For example, crime investigators may exploit the information on all vehicles using the parking in the vicinity of a crime scene and on their owners.

U.S. Pat. Nos. 6,246,337 and 6,249,233 to Rosenberg et al., disclose a vehicle parking network where each subscriber is equipped with a transmitter-responder device (TRD). The subscriber must attach a complementary box (CB) on the car, the CB being coupled to the TRD for communications with a central computer. A subscriber must find an empty parking spot recognized by the central computer, after which he/she has to contact the central computer by telephone for a parking authorization request. Parking is permitted after receipt of a parking authorization signal from the central computer. The CB has identification marks that can be scanned from outside the vehicle through the windshield in order to identify the subscriber. The absence of the CB renders the parking illegal.

The system of Rosenberg et al. does not provide any prior indication regarding existence of available parking spots in a particular parking area. In addition, advance reservation of a pre-determined parking spot is unavailable.

The current methods can be improved for better servicing the users and for increasing the revenue collected by the parking owners. There is a need to provide a user-friendly parking system without direct cash handling. In addition, there is a need to provide a system where the users pay for the actual parking time without being ticketed, whereas parking owners achieve maximum occupancy with minimum time violations. As well, there is a need for a centralized parking system, which allows the users to reserve in advance a parking spot in a desired parking area.

In addition, there is a need to collect additional information of the driver and the car for security sensitive parking spaces.

### SUMMARY OF THE INVENTION

The present invention seeks to overcome the disadvantages of the prior art parking systems. Thus, it is an object of the present invention to provide a centralized parking system, which allows reservation of a predetermined parking spot in a parking lot/area of interest. It is also an object of the invention to provide a user-friendly method of payment for the actual time of using the parking space.

A further object of the invention is to provide a parking system with enforcement means that takes into account mutual benefits for both the user and the parking authority.

According to one aspect of the invention, a parking system for enabling centralized parking reservation, payment and enforcement, comprises: a central computer for generating, managing and storing subscriber data and parking data and performing a plurality of parking operations; a user terminal connected to the central computer over a data network, for enabling user access to the central computer; a service terminal connected to the central computer over the data network for enabling automation of the parking operations; and a data portal provided for the central computer for enabling interactive communication of the subscriber data and parking data between the computer and the service terminal and the user terminal.

According to a further aspect, the invention provides a method for managing and controlling operation of a parking facility, to enable centralized reservation, payment and enforcement, comprising: connecting a parking system over a data network with a user terminal and a service terminal; registering a user with the parking system from the user terminal; on the user terminal, reserving a parking spot in the parking facility for a specified vehicle; monitoring the presence the vehicle in the parking spot and measuring an effective parking time for the vehicle; and calculating a parking fee for the effective parking time and processing the parking fee automatically according to a pre-arranged payment plan.

The system according to the invention provides an informed parking concept compared to the current uncertain “find & park” concept, presenting numerous advantages to both the parking user and the parking owner. An updated central database provides the current occupancy status of the area, so that the users can select the appropriate spot for the current use, which adds to customers satisfaction and increases parking fees generation. This database can be also used to provide statistical parking information that may be used for further improvements of the system.

Knowing in advance the location of the parking spot combined with the payment methods available with the system of the invention advantageously saves time to the users. In addition, the system of the invention allows to speed-up the access of vehicles in and out of large parking lots. This advantage is particularly relevant in case of concurrent events sharing a parking lot.

The invention provides an improved solution for the parking industry, by replacing the existing custom-made sophisticated parking meters and automatic cashiers with web-enabled mobile communications devices activated/deactivated for space assignment and collection of fees, which is automatic in some case, or is based on start-end user inputs in some other case. Correct calculation of the parking fee and convenient methods of payment (cashless) increase customer satisfaction and contribute to the success of the operation.

Moreover, the system deals with the unplanned overtime parking in a way that is satisfactory to customers, while the additional parking costs are debited to the appropriate parking authority. In addition, any overtime parking penalty is proportional to the time violated, as opposed to the flat high rate applied currently.

The system also provides for efficient parking lot supervision, which detects illegal parking and stores information to improve security protection. Thus, the system of the invention ‘knows’ the license plate of each vehicle using the facility, and maintains information regarding the user of the respective vehicle, which information is particularly useful in security sensitive areas.

The parking system according to the invention may also be used in large high-level rack storehouses to enhance space management as the merchandise is moved in and out. It may also be used by the car-rental companies to identify a rented vehicle by the parking space number and to facilitate the creation of a fleet of self-rent cars, to reduce use of private vehicles in the cities and to save on parking fees.

The “Summary of the Invention” does not necessarily disclose all the inventive features. The inventions may reside in a sub-combination of the disclosed features.

### BRIEF DESCRIPTION OF THE DRAWINGS

The foregoing and other objects, features and advantages of the invention will be apparent from the following more particular description of the preferred embodiments, as illustrated in the appended drawings, where:

FIG. 1 illustrates an embodiment of a parking system according to the invention;

FIG. 2 is a photograph of an optical reader installed at a parking facility according to the invention;

FIG. 3A is an example of a map used for metered parking spaces;

FIG. 3B is a map for a metered parking space located on a city street;

FIG. 4 illustrates an initial portal screen for customer registration;

FIG. 5 shows an example of a screen for advance parking reservation;

FIG. 6 is a flowchart illustrating the centralized advance parking reservation process and payment method according to the invention;

FIG. 7A is a flowchart illustrating the parking time measurement for parking facilities with automatic license plate reading;

FIG. 7B is a flowchart illustrating the parking time measurement for parking facilities without automatic license plate reading;

FIG. 8 is a flowchart illustrating an example of parking time enforcement procedures for un-metered parking areas; and

FIG. 9 is a flowchart illustrating an example of parking violation procedure may be handled.

Similar references are used in different figures to denote similar components.

### DETAILED DESCRIPTION OF THE PREFERRED EMBODIMENTS

The following description is of a preferred embodiment by way of example only and without limitation to combination of features necessary for carrying the invention into effect.

The Parking System

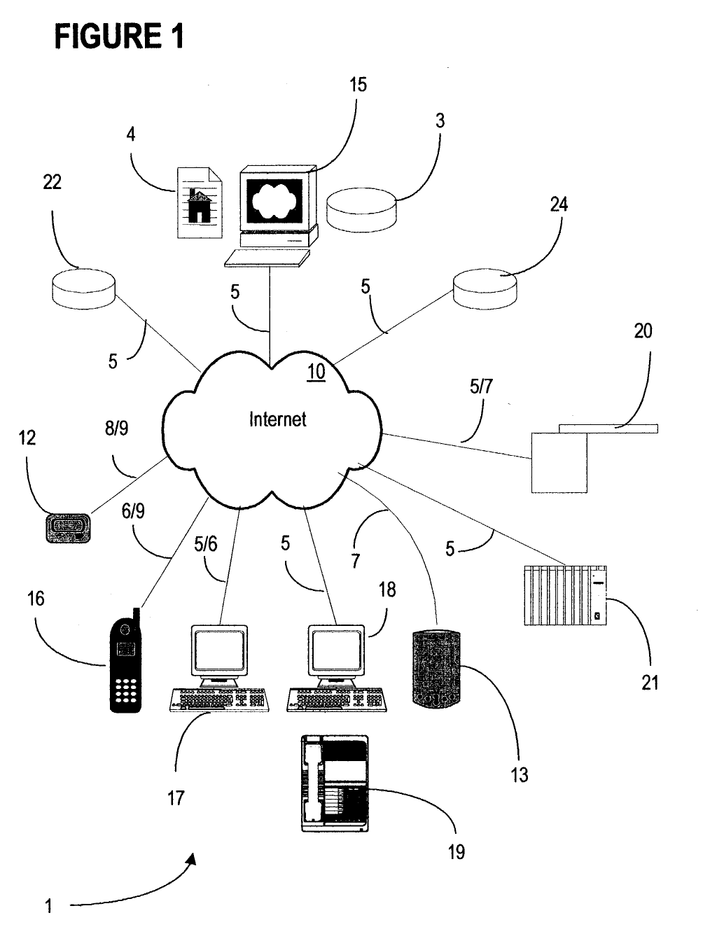

FIG. 1 illustrates an embodiment of the parking system with centralized registration, reservation, payment and enforcement according to the invention. Parking system 1 serves all types of parking facilities; FIG. 1 illustrates a complex embodiment suitable for a large corporation, which owns a plurality of parking facilities spread over a large geographical area

The system 1 is preferably an Internet-based computerized system, which communicates and interacts online with a plurality of terminals, while keeping records of all operations and transactions as desired by the parking facility management (also referred herein as the parking authority), within the framework of the existing local rules and regulations. FIG. 1 shows the Internet 10 connecting the central computer with the terminals, however any data networks may be used for enabling this communication.

System 1 includes in this example a central computer 15, with a relational database 3. Database 3 stores subscriber data such as user identification (ID), address, e-mail, password, vehicle details, and credit card details. A general user profile is also available. Additional information may be required regarding the driver and the car for example for parking spots where security protection is critical. This information is provided by subscribers upon registration and is maintained as long as the user decides to maintain his/her subscription.

The database also comprises parking facility data such as parking space identification ID (street, garage floor, area, lot). This information is stored e.g. in the form of maps that identify each spot or in the form of ‘bulk’ space when identification of each spot is not available (e.g. street parking). The parking facility data is updated when physical changes to a certain parking area or lot occur, or when new areas, lots or spaces are added.

The database also stores temporary information, such as parking time data, which information is provided when a parking request is logged. The parking time data may be maintained for a short period, for example until the account for the respective service has been settled. Optionally, the parking time data may be maintained for as long as agreed upon with the user, or as deemed necessary by the parking authority. Receipts of fee/charges are available online or on demand.

Database 3 may be organized as a relational database, by arranging the records as a set of tables, where each table is a set of records. In turn, a record is a set of fields and each field is a pair of field-name and field-value.

Computer 15 is programmed to perform a plurality of parking-related operations, such as subscriber registration, centralized advanced parking reservation, payment and enforcement. Device 15 is provided with digital signature capabilities such as for example PKI (public key infrastructure), and SWIM (subscriber wireless information module) capabilities, to provide authentication and confidentiality of user data (identification, debit/credit card information and activities), as well as for the parking area security protection. It may also supply statistical data regarding the customer profiles and the services requested, which enables the parking authority to further enhance the operation and revenue collection, while providing high quality services to users.

The system according to the invention also incorporates a geographic information system (GIS) or other system that allows automatic identification of a parking spot on a map of the respective parking lot/area, thus facilitating reservation of a spot of interest and easy localization of the spot in the preferred parking area. The users may access the system 1 in the known way, as shown by a HTML (Hyper Text Markup Language) portal 4, using a variety of web-enabled user terminals.

For example, the users may use a personal computer, notebook or laptop 17, with a dial-up interface 6, or an Ethernet interface 5 to the Internet 10 to register, to access the system and to interact with the system by requesting a parking service. Or, the user may use a WAP (wireless application protocol) cellular phone 16 with web browser capability, connected over the Internet using a dial-up interface 6 or a GPRS (General Packet Radio System) interface 9. Access over the Internet is not mandatory; the users may access system 1 over a telephone landline or a wireless line using an agent, who in turn has Internet access to the system.

Thus, for users that do not have an access terminal 16, 17 as in FIG. 1, the communication with system 1 may be established dialing a 1-800 number as shown at 19, to communicate with an operator (agent), who will perform the respective service such as e.g. registration, reservation, buying additional timer, payment, etc. using a service terminal 18. The agent's computer 18 is preferably connected to Internet over an Ethernet interface 5.

System 1 may also be provided with service terminals, such as voice portal 21, which enables users access to the system 1 by calling a toll-free number (1-800, or 1-888, etc) number. Voice portal 21 is an automated interactive system developed using VoiceXML technology, which harnesses the massive infrastructure developed for HTML to create and deploy voice applications over Internet. While HTML assumes a graphical web browser with display and keyboard/mouse, VoiceXML assumes a voice browser with audio output, audio input and keypad input. In this case, the voice browser's speech recognizer handles the audio input (user's voice commands). Audio output (device's 21 responses) consists both of recognition and speech synthesized by voice browser text-to-speech system. Voice portal 21 interfaces with Internet preferably over an Ethernet interface 5.

Preferably, for medium sized and large parking areas, the system incorporates license plate readers (LPR) 20, which provide automatic vehicle identification and trigger the parking process. The LPR shown at 20 is mounted for example on the gates to the parking lots and garages, so as to keep track of the vehicles entering and leaving the area. For parking facilities that are not equipped with gates, the LPR 20 may be mounted on any convenient structure from where the license plates of vehicles entering or exiting the facility may be read. The LPR 20 may be connected over data network 10 to computer 15 using a wireless interface 7 or Ethernet 5. When a car is entitled to use the respective facility, the LPR 20 sends a trigger signal that actuates gate opening and closing.

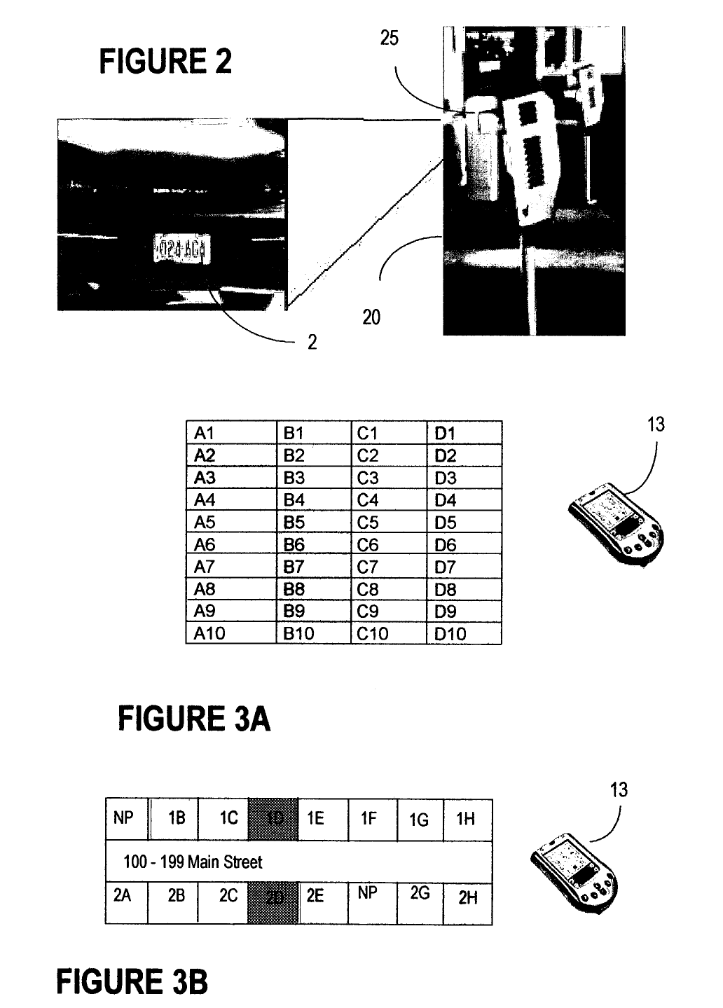

FIG. 2 illustrates a LPR 20 by way of example. These devices are equipped with a camera 25 which is oriented so as to “see” a large portion of the back of the car where the license plates 26 are fixed (since front license plates are not always compulsory). The license plate image is converted to data and is matched with the pre-stored car identity information, the time of entry or exit is sent to database 3 and recorded against the user ID. If the parking facility has a gate, a signal is sent to open/close the gate as required. Use of LPR 20 allows total automation of the vehicle/user identification, without any action on the part of the customer.

It is to be noted that the term “license plate reader” designates generically any means for automatically inputting the lice plate number. For example, it may be a digital camera, an optical card reader, a bar code reader, a PIN code reader, a magnetic card reader, or combinations thereof.

Some of the large garages/parking areas may already be equipped with a local database 24, which keeps track of the current lot/area occupancy, the existing reservations, and the time when a reservation starts and ends. This database may be used to load the relational database 3, when created, and to synchronize it whenever changes in the layout of the respective parking facility occur. Preferably, interface 5 that connects the database 24 to the web is Ethernet.

Service terminals 12 are relevant to large parking facilities that are provided with shuttle service, such as airport parking facilities. Terminals 12 are provided at convenient locations throughout the parking facility along the route of the shuttle, to enable the users to find out where the shuttle is and the time of arrival at the stop closest to his/her current location. To this end, the shuttle is equipped with a GPS (Geographical Positioning System), which transmits its position continuously to system 15, so that the location of the shuttle is always known. The terminals 12 may use for example a SMS (Short Messaging System) interface 8 or a GPRS (General Packet Radio System) interface 9.

Service terminal 13 illustrates a handheld wireless device used by a parking attendant (enforcer) for enforcing the parking regulations and for assisting subscribers when needed. Terminal 13 could be a generic web-enabled wireless terminal, which communicates with system 15 over a WiFi interface 7 for speedy, on-line processing of information. Terminal 13 is preferably equipped with GPS and a digital camera, or optical card reader (OCR), and the appropriate software process applications, for reading the license plate of a vehicle and uploading the information to system 15. This information is used for updating the parking occupancy information, and it may also be used to read the license plate of vehicles for which the parking was prepaid, upon entry at a sport/show event for speeding-up the parking operations.

The enforcer's terminal 13 also enables the enforcer to download the expected parking occupancy information, to identify eventual offenders and to take appropriate actions. For example, the terminal downloads mapping of the parking space identification to car license plates, and the enforcer determines which cars are illegally parked, checks which cars have “over-parking” protection, issues parking tickets, requests that illegally parked cars be towed, etc. In addition, the enforcer's terminal may automatically inform the user by e-mail that the vehicle has been towed, and provide the address where it could be picked-up. A time and date stamped picture of the car may be used as proof of offense in the court, or to justify any extra charges even when the user has over-parking protection.

Terminal 13 may also be equipped with a magnetic card reader and a printer, so as to enable on the spot payment for quick entry into the parking lot at a sport/show event.

FIG. 1 also shows that central computer 15 is connected to the Department of Motor Vehicle database 22 allowing integration of the information in the relational database 3 with the information in the DMV database 22. Thus, the information on delinquent cars can be sent from computer 15 or from the hand-held device 13 to the local authority or states Department of Motor Vehicles (DMV) database 22 to identify repeat offenders for appropriate enforcement in traffic courts. This also replaces the present manual parking ticketing process.

Integration of Parking Facilities with the Parking System

As discussed in connection with the relational database 3, system 1 maintains maps for all parking facilities administered by the respective owner. The type of parking facilities varies widely, and the operation of the system 1 differs accordingly.

A parking area may for example be a garage with one or more floors, or an area with a plurality of parking lots, each parking lot with the respective parking spots/spaces. In general, the spaces in such areas are identified (numbered) to enable the users to locate the car. FIG. 3A is an example of a map used for numbered parking spaces located in a large commercial area. Also as a convenience to the subscribers to system 1, the numbered parking spots in this type of facilities may be advertised to indicate if the respective spot is occupied, reserved, free or reserved for special parking (handicapped persons, pregnant women, mother and child, etc). As well, the occupied spots may also display the license plate of the car or the name of the individual that should use it. This information will aid the subscriber to find her/his reserved spot, and will discourage illegal parking.

The parking system of the invention may also be used for operating the street parking spaces that are traditionally controlled and enforced by means of specialized local metering. Either no meter is required or no special arrangements are needed in this case, as the system makes use of the number on existing parking meters, which identifies uniquely the parking space. System 1 also operates with parking spaces in a city block or other traditional parking areas using a concrete block, a pole, a parking meter, or any other mainstay physical property designating the parking spots with an identifying number. FIG. 3B is a map for a metered parking space located on a city street.

Another example of parking spaces, which are generally administered by the city, refers to the street parking spots that are not metered/numbered, where parking is allowed for a limited time. Currently, an enforcer patrols the streets and identifies the offenders, providing manual, and thus not very accurate, records of offending cars.

According to the invention, the maps, such as the ones shown in FIGS. 3A and 3B, may be displayed on the user's access terminal, in this example a terminal 17 in FIG. 1. The user terminal 17 displays the parking spots and their characteristics: reserved/occupied such as spots A2-A3, B5-B9 and D1-D2 shown in gray, free spots such as C1 to C10, and spaces A8, A9, D8-D10, shown in light gray, reserved for handicapped persons. The maps may also be downloaded on web-enabled terminals 16.

Payment methods

System 1 can work with several payment methods. Calculation of the total parking fees and automatic payment for pre-approved users ensures collection of the correct parking fees on line. In addition, the fee can be paid conveniently, using various payment instruments like credit cards, debit cards, decreasing balance, a third party billing system (micro payment), or any other smart card/prepayment method.

The option payments are numerous; the user may choose to pay by the minute/hour/day/week and/or start-end period activated/deactivated by customer's access terminal.

Rates can be flexible and can be adjusted instantaneously. In all cases, payment arrangements can be made according to a tier system, particularly in large parking areas/lots. A premium may be charged based on factors that the parking area authority deems acceptable, such as distance from the parking spot to the main entry or to the venue. The arrangement may also charge higher prices for spots close to the user's interest and decreasing as the distance to the respective place increases. Also, certain times of the days that are more valuable than others may be offered at a premium. “Auctioning of parking spaces” is a process, which can be initiated manually or automatically once a certain percentage of parking spots have been reserved, and the value of the remaining ones becomes so much higher that it is profitable to auction them. Links to other websites and company promotions may also be available in order to give more choices to the customers. Examples of such sites are frequent flyer, car service/maintenance companies, other events similar to the ones the customer chooses, etc.

As mentioned before, the payment methods are secure, as system 15 incorporates digital signature Public Key Infrastructure (PKI) and Subscriber Wireless Information Module (SWIM) technology. Any other security technology that conforms to the complete automation of the parking process may be used.

On-line prepayment of the parking is an important advantage of the present invention, as the user does not have to carry money or a credit card, and can always reserve a parking spot and be legally parked.

The customer may also choose “over-parking protection”. If the time parking period initially selected elapses, the customer is automatically charged for the rest of the hour/day depending on customer's desired level of protection, instead of being ticketed or the car being towed away. In any event, irrespective of the selected parking period, the customer is always charged for the effective time the car occupies the parking spot, if the start-end feature is selected.

This is another advantage of the invention, as the customer is not bound to a pre-paid parking period and can continue an activity without facing illegal parking condition.

Receipts of all parking transactions may be stored in database 3 and can be used for statistical analysis or for resolving disputes. On-line receipts are available for the lifetime of the registration (membership) and can be issued from a user access terminal.

To summarize, system 1 can be adapted to various types of parking facilities, payment methods, enforcement methods and provides the users with a variety of services that make it very attractive. For example, the system enables operations such as advanced reservation of a parking space, recording of the effective parking time, and enforcement capabilities adapted to the type of parking.

All users must register first with the system in order to receive the desired services. Registration is performed as well known by selecting a user name and a password to access the respective website 4. The user must then provide his/her name, address information, vehicle information and payment information.

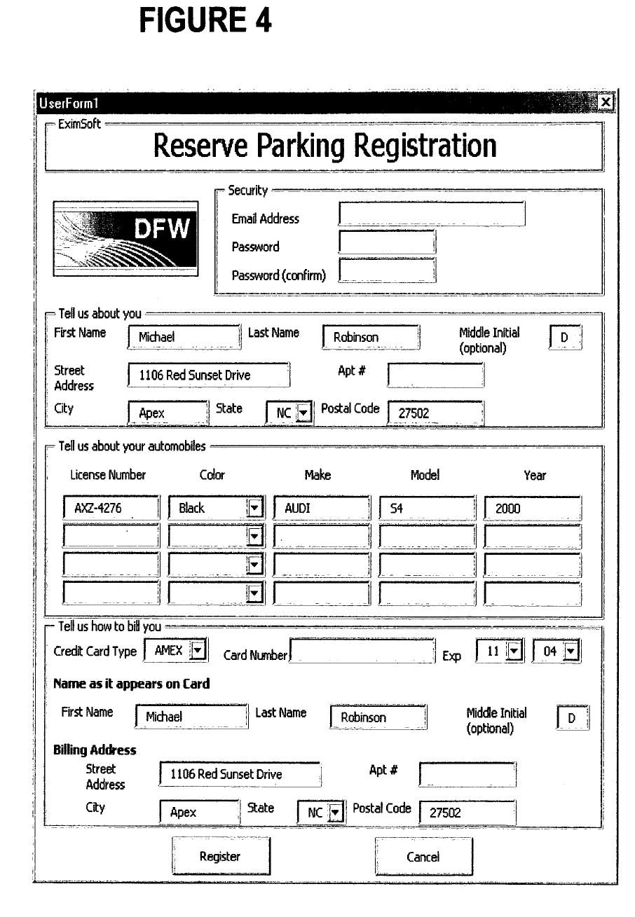

FIG. 4 illustrates an example of an initial portal screen for customer registration. This type of registration is common to web-enabled services. The user ID may for example be the serial number of the user terminal. The vehicle ID requires license number (LN), color, make, model, year, etc for all vehicles that the subscriber intends to use. The payment information may include alternative methods of payment and options such as over-parking protection.

As discussed above, secrecy of this information is guaranteed as the user interface to computer 15 incorporates digital signature Public Key Infrastructure (PKI). It is to be noted that any other authentication infrastructures may equally be used as needed and as they become available. As well, the system according to the invention improves parking venue security protection by advance identification of the vehicle and the customers making the parking reservation request.

Advanced reservation.

According to the invention, a subscriber to system 1 may reserve a parking spot in advance using a terminal such as 17. A user may request a parking reservation (in advance of the service) or may reserve the parking on the spot (parking at the moment). Advanced parking reservation is available only for the spaces that are marked or metered. Parking on demand is available in all parking facilities, be they marked, metered, or not.

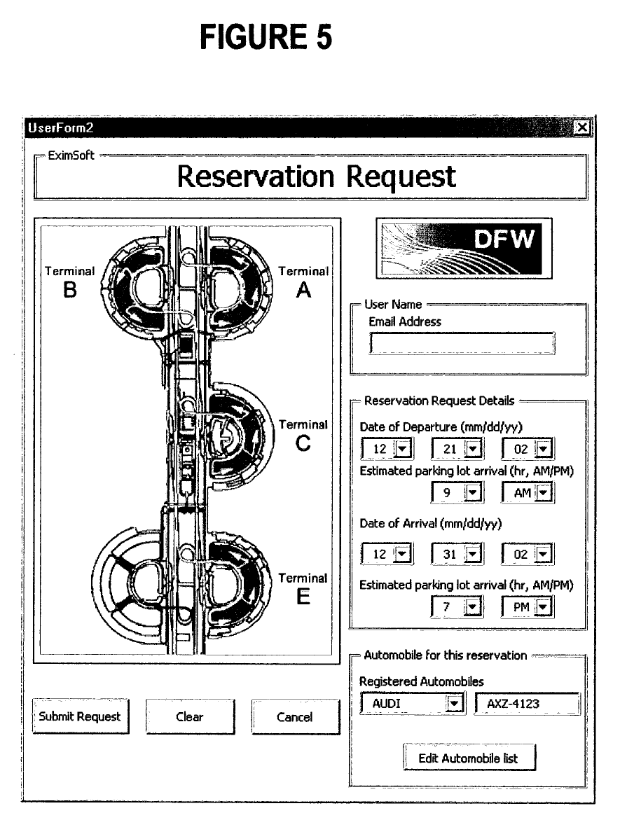

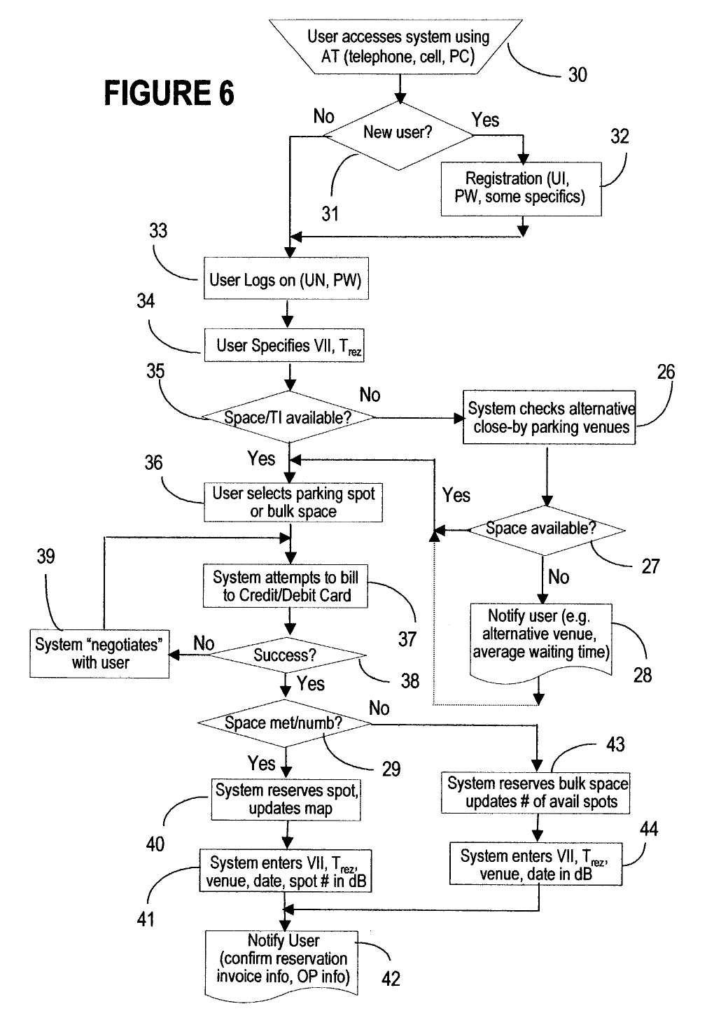

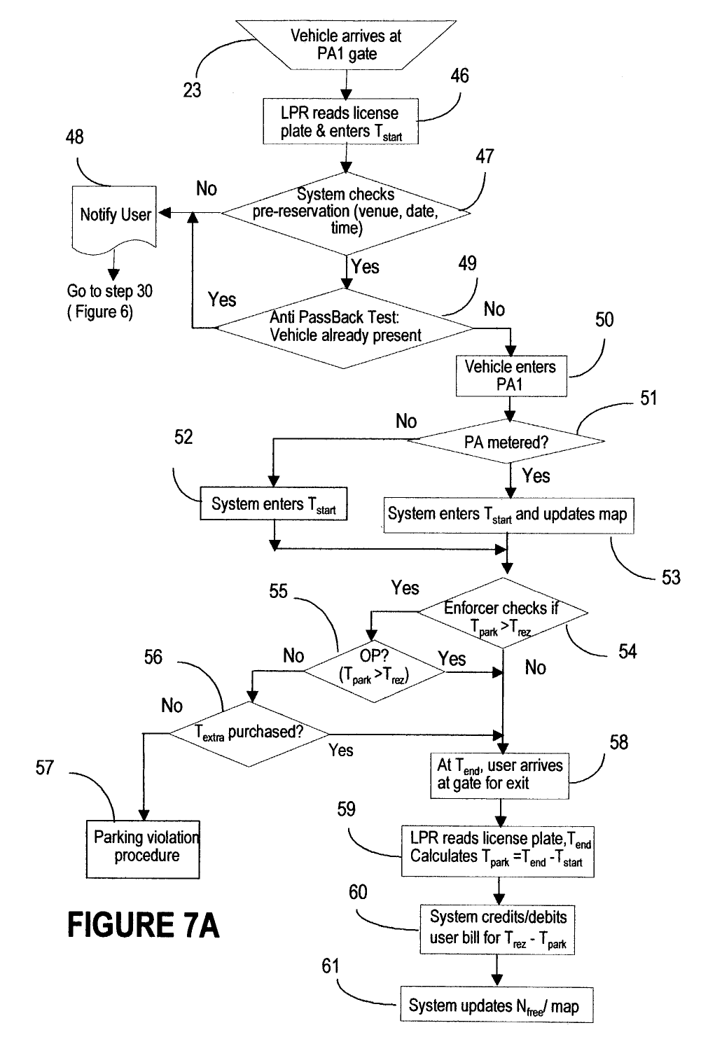

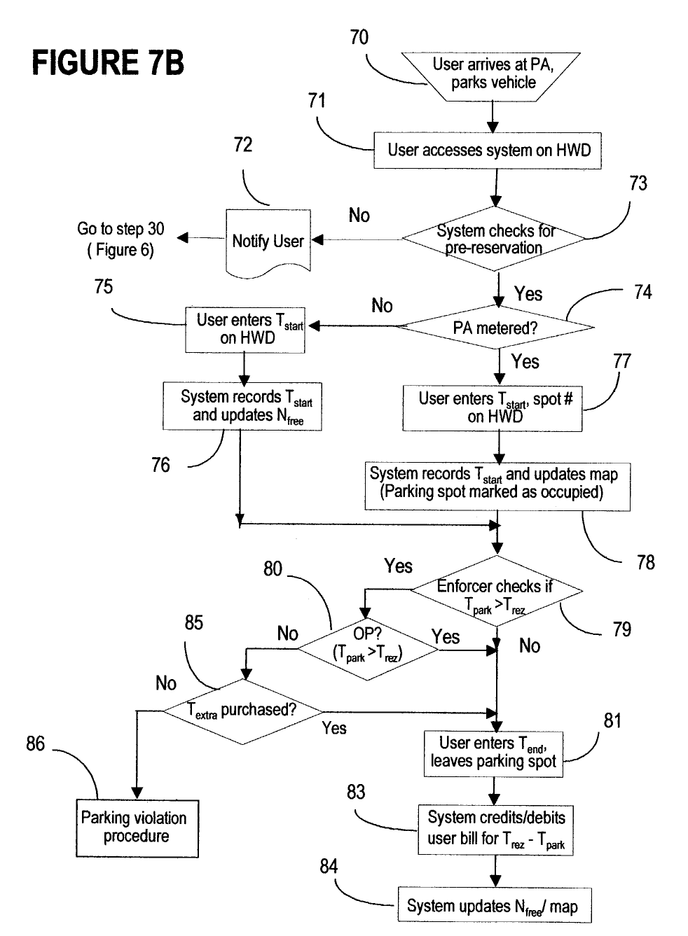

FIG. 5 illustrates an example of a screen for advance parking reservation and FIG. 6 is a flowchart illustrating the advance reservation process and the method of payment according to the invention.

The reservation process begins with the user accessing system 1 using for example as the access terminal the desktop computer 17, step 30. If an account for this user already exists, branch “No” of decision block 31, the user logs-in as well known, by providing his/her user identification UI and password PW, as shown in step 33.

If a new user requires a parking reservation, branch “Yes” of decision block 31, the data for the new user is collected, as discussed in connection with FIG. 4. For example, the system may require user's name, address, phone, email address, type of car and license plate number, as described in connection with FIG. 4. The user then provides the system with the parking request information, as shown in step 34 and illustrated by way of example in FIG. 5. This information includes at least venue identification information (VII) and time information (TI). The venue is specified as detailed as desired, and the time as specific as possible, indicating the date, the expected time of arrival Tₛₜₐᵣₜ and the expected duration of the parking T_{rez}.

The subscriber must also specify the automobile make if there are more automobiles registered to the respective subscriber. In case of large parking facilities, the subscriber may specify some particulars of the spot, such as floor number, terminal and gate number (e.g. for airport parking). Once system 1 receives the particulars of the request (VII, TI), a map with the area of interest showing the parking spots and their identification is displayed on the subscriber terminal. More particularly, the availability and usage status of the spaces closest to the place of interest is displayed on-line in real-time, so as to allow the user to select the preferred spot.

If a parking spot is found, as shown by branch “Yes” of decision block 35, the user selects a convenient spot, or selects a bulk space with available spots, step 36. As discussed before, auctioning for better spots is available.

Next, system 1 attempts to bill the service to the credit/debit card number, step 37. The user now specifies the payment method and payment type. To reiterate, the user may select payment by debit/credit card, decreasing balance, etc. It is noted that a subscriber has the option to maintain the number of a credit card in the parking system in order to speed-up the reservation procedure, and to direct the parking costs to one card. Alternatively, the user may enter the card information at the moment of parking, in which case the card number is entered in step 37. As also described previously, the parking time may be specified in various units of time, such as days, hours, minutes, seconds. Over-parking protection option may also be activated now for this particular parking action.

If the card verification in step 38 fails, the customer may re-try with the same or a different card, steps 37 and 38, and if this again fails, the subscriber cannot reserve the spot. This procedure is not shown in detail, as being well known for on-line transactions.

Needless to say that if at step 35 a parking spot is not available at a facility of choice, as shown by branch ‘No’ of decision block 35, the customer is notified to try another parking facility in the vicinity, step 26. If a parking spot is not available at all as shown by branch ‘No’ of decision block 27, the user is notified in step 28, and the reservation process ends. If a spot is available in another parking area close to the respective point of interest to the subscriber, as shown by branch ‘Yes’ of decision block 27, the process continues with step 36 as described before.

If the transaction is successful, branch ‘Yes’ of decision block 38, and the spaces are numbered, branch ‘Yes’ of decision block 29, the system reserves the spot, step 40. The database 3 is updated to show the newly reserved space, step 41, and the user receives a confirmation of reservation and invoice information, step 42.

If on the other hand, if the spaces in the parking are not metered or numbered, branch ‘No’ of block 29, the operations proceed in a similar way, with the exception that the system does not reserve a space. Instead, the system reserves a spot in a bulk space by decreasing the number of free spaces in the respective bulk space, as shown in step 43. In this case, the subscriber will find the reserved spot, since the bulk parking area with the respective reserved space is confined to a block or two. The system enters the VII and T_{rez} in the database in step 45 (but no parking space number), and the subscriber receives confirmation of parking reservation as before, as shown in step 42.

It is obvious that in the absence of a terminal 17 the subscriber may still reserve a space in advance using a telephone or a cellular, in which case an attendant will perform the reservation on the map.

Advance parking reservation is one of the main advantages of the system 1, which allows customers to reserve desired parking spots in advance without facing the risk of going “blindfolded” in search of a parking spot.

FIG. 7A is a flowchart illustrating the parking time measurement for parking areas equipped with automatic license plate reading. In this scenario, the entry and exit time are read and entered into the system automatically.

When the vehicle arrives at parking, step 23, the license plate reader (LPR) 20 takes a picture of the car license plate, step 46. The LPR matches the license plate number with the information in the database 3, as shown in step 47, and the vehicle is allowed to enter if the subscriber has reserved a spot, as shown by branch ‘Yes’ of the decision block 47. The LPR also reads the time of entry and stores it in the system database (Tₛₜₐᵣₜ).

If a reservation is not found in the database 3 for the respective car, the subscriber is notified, step 48, and requested to proceed with reservation, i.e. to perform the steps shown in FIG. 6. The user can log-on the system if he/she is a registered user to determine what went wrong, and/or may try to reserve a spot at that moment, using an access terminal such as 16, or a cellular/fixed telephone dialing the 1-800 number to contact the agent 18.

If the advanced reservation is found in database 3, as shown by branch ‘Yes’ of decision block 47, an Anti PassBack test is performed in step 49. This test is performed for detecting eventual duplication in the license plate numbers (e.g. typos made by users at registration, fraud, etc). The users may be notified of the duplication for correcting the typo, or the authorities are notified in case of fraud. If the test fails and a car is already using the spot as shown by branch ‘Yes’, the subscriber is notified and as shown in step 48, he/she is requested to perform the same actions as above in connection with the reservation check. If the Anti PassBack test is successful, branch ‘No’, the vehicle enters the parking facility, step 50, and the user drives it to the reserved spot.

Now, if the parking area is numbered (i.e. the spots are numbered), as shown by the branch ‘Yes’ of decision block 51, the system updates the map to show that the reserved spot is now occupied, step 53. If the parking area is not numbered, the system only associates the time of entry Tₛₜₐᵣₜ, provided by the LPR against the subscriber/vehicle identity, step 52.

The enforcer patrols the parking area and checks if the actual time of parking Tₚₐᵣₖ exceeds the time reserved T_{rez}, as shown by decision block 54. The enforcer is equipped with a hand-held device such as 13, which enables access to the system at all times, and he/she can check the status of each car. As indicated in connection with FIG. 1, hand-held device 13 may be a generic web-enabled wireless terminal with GPS and digital camera capabilities, with appropriate software process applications.

A parking spot is flagged in the database (on the map) for attendant's attention when the reserved parking time was exceeded. If the parking time Tₚₐᵣₖ exceeds the time reserved T_{rez} for a certain vehicle, branch ‘Yes’ of block 54, and if over-parking protection is not available for the respective subscriber, as shown by branch ‘No’ of decision block 55, then the enforcer checks if additional parking time has been requested by the respective subscriber, as shown by step 56. If the system indicates that no additional time has been purchased, branch ‘No’ of block 56, the vehicle is considered as illegally parked and a parking violation procedure is initiated in step 57. A digital picture may be taken and an e-ticket, or an e-mail explaining the tow information may be sent to the customer. If the illegally parked car is not in the reservation database, it will be ticketed/towed and the information regarding the illegal vehicle stored in the enforcement database for subsequent use.

If the subscriber has overtime protection branch ‘Yes’ of decision block 55 and or has purchased additional parking time, branch ‘Yes’ of decision block 57, the enforcer considers the vehicle as legally parked and continues checking other cars.

When the vehicle exits the parking facility and arrives at the gate for leaving, step 58, the LPR 20 reads again the license plate, step 59 and the time T_{end}, and sends the information to the central computer 15. The actual parking time Tₚₐᵣₖ is calculated as the difference between the T_{end} and Tₛₜₐᵣₜ, and compared with the initially reserved period (T_{rez}), and the effective duration of parking is charged to the customer account. Thus, if Tₚₐᵣₖ>T_{rez}, the user is notified, step 60 and billed for the difference. If Tₚₐᵣₖ<T_{rez}, the user account id debited with the difference.

After the vehicle exits the parking, the system updates the database 3 by marking the respective parking spot as free, step 61.

FIG. 7B is a flowchart illustrating the parking time measurement for parking areas without automatic license plate reading. In this scenario, the subscriber must be equipped with a handheld wireless device HWD such as device 16 on FIG. 1 for entering the arrival and the departure time into the system. The user arrives at the parking spot as shown in step 70 and accesses the system 1 on the handheld wireless device, step 71. The system checks if there is any advanced reservation for that user, as shown in step 73. If not, the subscriber is notified in step 72 and he/she proceeds with reserving a parking spot using the handheld wireless device (HDW) 16, as shown in the flowchart of FIG. 6. If the subscriber has already reserved a parking space in the respective facility, as shown by branch ‘Yes’ of decision block 73, the user proceeds with parking in the reserved spot. If the parking area is numbered/metered, as shown by branch ‘Yes’ of decision block 74, the user parks the car in the reserved numbered space and enters the parking start time Tₛₜₐᵣₜ and the space identification number, as shown in step 77. Then the system records the time Tₛₜₐᵣₜ and updates the map to show that the respective parking space is unavailable for the reservation time T_{rez}, step 78.

If the parking area is not numbered/metered, branch ‘No’ of decision block 74, the user parks the car in a respective free space and enters the parking start time Tₛₜₐᵣₜ, as shown in step 75, and the system records the time Tₛₜₐᵣₜ and updates the number of free parking spaces available in that parking area, step 76.

During the time of parking, the enforcer controls the legality of all cars parked in the respective area. The handheld device 13, communicates with system 1 to advise which cars have been parked for more than the reserved time, step 79, and also checks if the owners of the cars with Tₚₐᵣₖ>T_{rez} have over-parking protection, step 80. As before, if the vehicle is parked illegally (reserved parking time expired, the owner does not have over-parking protection and he/she did not purchase any additional parking time in step 85), the parking violation procedure is applied to that car, shown in step 86.

If on the other hand, the reserved parking time did not expire, branch ‘No’ of block 79, or if the user has over-parking protection, branch ‘Yes’ of block 80, or if he/she purchased additional parking time, branch ‘Yes’ of block 85, the enforcer considers the vehicle as legally parked and continues checking other cars.

When leaving the parking facility, the user enters the time on the HWD, step 81, and the system settles the account in accordance with the time effectively used for parking, step 83. In the meantime, the system updates the records/map to show the parking spot as available, step 84.

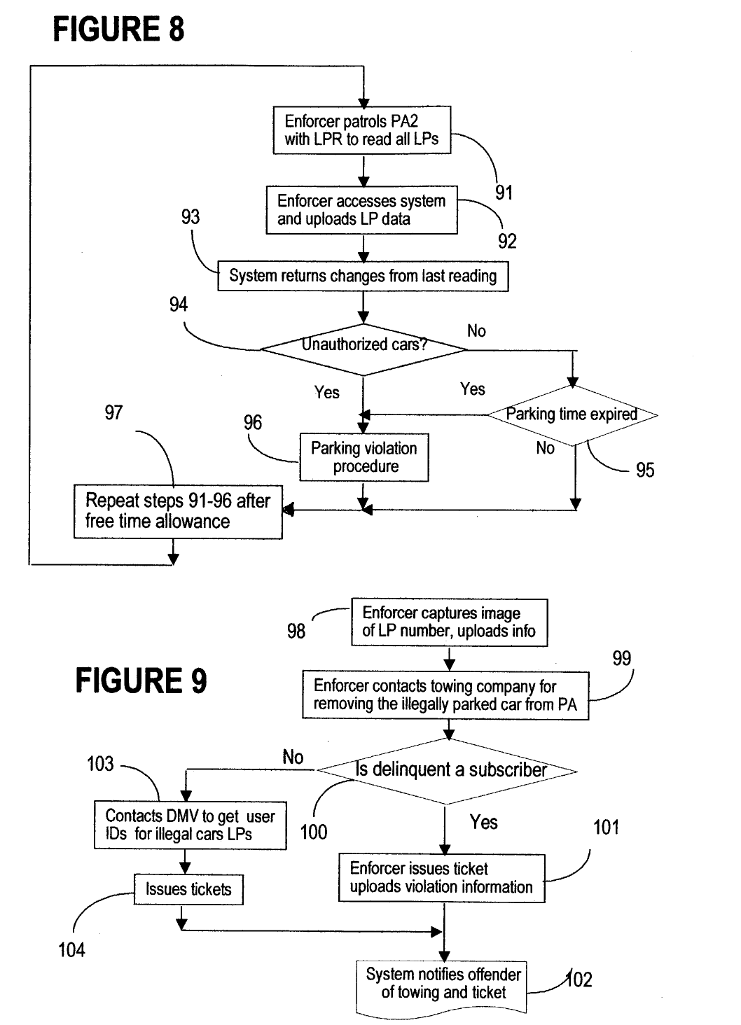

FIG. 8 is a flowchart illustrating an example of parking time enforcement procedures for un-metered parking areas (free limited time parking). In this scenario, the enforcer patrols the area and enters the license plate numbers and the time for all parked cars, step 91. This is a very simple operation, in that he/she only has to direct the device 13 towards the license plate of each vehicle and takes a picture of the license plate. After the license plates of all cars were photographed, the enforcer accesses system 1 and uploads the license plate information, as shown at step 92. On enforcer's request, system 1 downloads on device 13 the changes form the last reading in the area under his/her administration, step 93. The system informs the enforcer of any vehicles that are not authorized to park in that area (if for example this is an area administered by system 1, where all users require subscription). If the vehicle is not in the database 3, branch “Yes” of decision block 94, or if it is, but the parking time expired, branch ‘Yes’ of decision block 95, the enforcer applies the parking violation procedure, as shown in step 96. If the vehicle belongs to a subscriber and the parking time has not expired, as shown by branch ‘No’ of decision blocks 94 and 95, the enforcer considers the vehicle as legally parked and continues checking other cars. As shown by block 97, the procedure is repeated after a certain time, calculated according to the free time parking allowance in the respective area.

FIG. 9 is a flowchart illustrating an example of how parking violation may be handled. Once a parking violation is detected in any of the above scenarios, the enforcer captures a date and time stamped image of the delinquent car, as shown in step 98. Thereafter, he/she contacts the towing company for removing this car, step 99. If the offender is a subscriber to system 1, branch ‘Yes’ of decision block 100, the enforcer eventually uploads violation information and issues a ticket to the subscriber, as shown in step 101. Then, system 1 notifies the user (e.g. by e-mail, or by regular mail) of the towing and ticket, step 102. If the offender is not a subscriber to system 1, the system interacts with the Department of Motor Vehicle database 22 to extract the users information, step 103. Once the user ID is known, the enforcer issues a ticket as shown in step 104. Next, he/she advises the offender of ticket and towing step 102. It is to be noted that various parking violation procedures can be devised, according to the local parking laws and practice.

Numerous modifications, variations, and adaptations may be made to the particular embodiments of the invention without departing from the scope of the invention as defined in the claims.

We claim:

1. In a parking facility of the type comprising a plurality of parking spots provided over a geographical area, a parking system for enabling centralized parking reservation, payment and enforcement, comprising:
a central computer for generating, managing and storing subscriber data and parking data and performing a plurality of parking operations;
a user terminal connected to said central computer over a data network, for enabling user access to said central computer;
a service terminal connected to said central computer over said data network for enabling automation of said parking operations; and
a data portal provided for said central computer for enabling interactive communication of said subscriber data and parking data between said computer and said service terminal and said user terminal.

2. A parking system as claimed in claim 1, wherein said user terminal is a data terminal provided with a keyboard for inputting said subscriber data and parking request data to said central computer and a display for displaying said parking data received from said central computer.

3. A parking system as claimed in claim 2, wherein said data network is the Internet and said user terminal is connected to Internet over one of a dial-up and an Ethernet interface.

4. A parking system as claimed in claim 2, wherein said user terminal is a web-enabled wireless terminal using a wireless interface.

5. A parking system as claimed in claim 4, wherein said data network is the Internet and said wireless interface is one of a dial-up and a General Packet Radio System interface.

6. A parking system as claimed in claim 1, wherein said user terminal is an automated voice interactive system comprising:
means for converting input audio signals including subscriber information and parking information into said subscriber data and parking request data, and transmitting said data to said central computer over said data network, and
means for synthesizing said parking data and instructions received from said central computer into output audio signals.

7. A parking system as claimed in claim 1, wherein said service terminal is a license plate reader (LPR) for acquiring an image of a license plate number (LPN) of a vehicle, converting said image into an LPN reading and automatically transmitting said LPN reading to said central computer over said data network.

8. A parking system as claimed in claim 7, wherein said LPN reading comprises a license plate field and a date/time field.

9. A parking system as claimed in claim 7, wherein whenever said parking facility is equipped with a gate, said central computer transmits to said gate a trigger signal for actuating said gate, if said LPN reading identifies a vehicle that has a reserved parking spot within said parking facility.

10. A parking system as claimed in claim 1, wherein said service terminal is provided with a keyboard for inputting current parking occupancy data to said central computer and a display for showing expected parking occupancy data received from said central computer, for detecting illegally parked vehicles.

11. A parking system as claimed in claim 1, wherein said service terminal is a web-enabled handheld device equipped with means for acquiring an image of a license plate number (LPN) of a vehicle within said parking facility, converting said image into an LPN reading and automatically transmitting said LPN reading to said central computer over said data network.

12. A parking system as claimed in claim 11, wherein said LPR reading comprises a license plate field and a date/time field.

13. A parking system as claimed in claim 11, wherein said LPR reading comprises a license plate field, a date/time field and a parking spot number field.

14. A parking system as claimed in claim 1, wherein said service terminal is a web-enabled handheld device comprising:
means for acquiring an image of a license plate number (LPN) for a vehicle within said parking facility and converting said image into an LPN reading;
a GPS reader for providing a geographical position reading for said vehicle in said parking facility; and
means for automatically transmitting said LPN reading associated with said position reading and a time/date field to said central computer over said data network.

15. A parking system as claimed in claim 14, wherein said service terminal further comprises means for inputting a request to said central computer for expected parking occupancy data, and means for displaying a map with expected parking occupancy data received from said central computer for identifying illegally parked vehicles.

16. A parking system as claimed in claim 1, wherein said service terminal is a data terminal operated by an agent on instructions received from a subscriber, said service terminal being provided with a keyboard for inputting said subscriber data and parking data to said central computer and means for displaying said parking data received from said central computer.

17. A parking system as claimed in claim 1, further comprising a shuttle locator for receiving shuttle position data and converting same to any of audio and visual information.

18. A parking system as claimed in claim 1, wherein said central computer maintains a relational database wherein a record includes subscriber identification data, vehicle identification data, a payment type and a payment method available for the respective subscriber.

19. A method for managing and controlling operation of a parking facility, to enable centralized reservation, payment and enforcement, comprising:
connecting a parking system over a data network with a user terminal and a service terminal;
registering a user with said parking system from said user terminal;
on said user terminal, reserving a parking spot in said parking facility for a specified vehicle;
monitoring the presence said vehicle in said parking spot and measuring an effective parking time for said vehicle; and
calculating a parking fee for said effective parking time and processing said parking fee automatically according to a pre-arranged payment plan.

20. A method as claimed in claim 19, further comprising uncovering an illegal vehicle in said parking facility and applying a parking violation procedure for said illegal vehicle.

21. A method as claimed in claim 19, wherein said step of registering comprises accessing said parking system remotely from said user terminal; providing said parking system with user, vehicle, and payment information; and selecting a user ID and a password for secure access and use of said user, vehicle, and payment information.

22. A method as claimed in claim 19, wherein said step of reserving a parking spot comprises:
providing from said user terminal to said parking system a parking request specifying a parking facility, a parking time and a parking duration T_{rez};
receiving from said parking system on said user terminal a map of said parking facility, which specifies all parking spots available for said parking and parking duration T_{rez};
selecting from said user terminal said parking spot on said map and negotiating payment with said parking system for said parking spot; and
at said parking system, marking said parking spot as reserved if payment negotiations are successful and updating said map to show said parking spot as reserved.

23. A method as claimed in claim 22, wherein said map comprises the parking spots of said parking facility, with parking spot status information attached.

24. A method as claimed in claim 22, wherein said step of reserving is performed in advance of said parking time.

25. A method as claimed in claim 22, wherein said step of reserving further comprises purchasing over-parking protection for said parking spot.

26. A method as claimed in claim 19, wherein said step of monitoring comprises marking the start time Tₛₜₐᵣₜ when said vehicle occupies said parking spot; and marking the exit time T_{end} when said vehicle leaves said parking spot.

27. A method as claimed in claim 26, wherein said steps of marking comprise automatically reading said Tₛₜₐᵣₜ and T_{end} with a license plate reader, transmitting said Tₛₜₐᵣₜ and said T_{end} to said parking system, and verifying if said parking spot is reserved for said vehicle.

28. A method as claimed in claim 26, wherein said subscriber inputs the license plate number of said vehicle associated with said respective Tₛₜₐᵣₜ and T_{end} on a user terminal.

29. A method as claimed in claim 19, wherein said step of monitoring further comprises, at preset intervals, reading the license plate number (LPN) of said vehicle parked in said parking spot with a service terminal; measuring the actual parking time Tₚₐᵣₖ for said vehicle; transmitting said LPN and said Tₚₐᵣₖ to said parking system; and comparing said Tₚₐᵣₖ with said T_{rez}.

30. A method as claimed in claim 26, wherein said step of calculating said parking fee for said effective parking time comprises calculating Tₚₐᵣₖ=T_{end}−Tₛₜₐᵣₜ and charging said subscriber for said Tₚₐᵣₖ.

31. A method as claimed in claim 30 further comprising applying an additional fee for any additional parking time T_{end}−T_{rez} whenever over-parking protection has been purchased in advance.

32. A method as claimed in claim 20, wherein said step of uncovering comprises:
at preset intervals of time, reading the license plate number LPN of said vehicle parked in said parking spot with a service terminal, and transmitting said LPN to said parking system;
receiving from said parking system status data indicating that an illegal vehicle is parked in said parking spot; and
initiating a parking violation procedure for said illegal vehicle.

33. A method as claimed in claim 32, wherein an illegal vehicle is one of:
(a) a vehicle which is not registered with said parking system;
(b) a vehicle which belongs to a subscriber to said parking system, has T_{rez}=0 for the respective parking spot and does not have over-parking protection.

34. A method as claimed in claim 32, wherein said parking violation procedure comprises, for an illegal vehicle (a):
obtaining from the Department of Motor Vehicles DMV the identity data for the owner of said illegal vehicle;
initiating towing of said illegal vehicle or initiating special security protocols based on said identity data;
issuing a parking ticket based on said identity data; and
informing said owner of said ticket and of the address of the current location of said illegal vehicle after towing.

35. A method as claimed in claim 32, wherein said parking violation procedure comprises, for an illegal vehicle (b):
initiating towing of said illegal vehicle;
obtaining from said parking system the identity data for said subscriber;
issuing a parking ticket to said subscriber based on said identity data; and
informing said subscriber of said ticket and of the address of the current location of said illegal vehicle after towing.
